(19) United States
(12) Patent Application Publication
(10) Pub. No.: US 2026/0319993 A1
(43) Pub. Date: Oct. 15, 2026

(54) ELECTRONIC SYSTEM

(71) Applicant: STMicroelectronics International N.V., Geneva (CH)

(72) Inventor: Cheick Ahmed Tidiani Haidara, Grenoble (FR)

(21) Appl. No.: 19/644,333

(22) Filed: Apr. 10, 2026

(30) Foreign Application Priority Data
Apr. 11, 2025 (FR) FR2503905

(51) Int. Cl. G06F 15/78; G06F 13/40

(52) U.S. Cl. CPC G06F 15/7803; G06F 13/4004

(57) ABSTRACT

The present description concerns a system comprising a main assembly of circuits and an auxiliary assembly of circuits, the main and auxiliary assemblies comprising the same circuits, each circuit of the main assembly being configured to deliver at least one output signal intended to be compared with an equivalent output signal generated by a circuit of the auxiliary assembly, at least one circuit of the auxiliary assembly comprising a functional block, equivalent to a functional block of the main assembly, disabled. The disabled functional block does not take part in the generation of output signals of the auxiliary assembly intended to be compared with signals of the main assembly.

### CROSS-REFERENCE TO RELATED APPLICATIONS

This application claims the priority benefit of French Patent Application No. FR2503905, filed on Apr. 11, 2025, entitled "Système électronique," which is hereby incorporated herein by reference to the maximum extent allowable by law.

### TECHNICAL FIELD

The present disclosure generally concerns electronic systems, and in particular electronic systems with a so-called "LOCKSTEP"-type structure, that is, with two identical circuits for processing the same data.

### BACKGROUND

"LOCKSTEP"-type systems are fault-tolerant computer systems having circuits identical to each other executing the same set of operations in parallel. Redundancy enables to detect and correct errors. Indeed, the results of the duplicated operations can be compared to determine whether an error has occurred.

### SUMMARY

An embodiment provides a system comprising a main assembly of circuits and an auxiliary assembly of circuits, the main and auxiliary assemblies comprising the same circuits, each circuit of the main assembly being configured to deliver at least one output signal compared, or intended to be compared, with an equivalent output signal generated by a circuit of the auxiliary assembly, at least one circuit of the auxiliary assembly comprising a functional block, equivalent to a functional block of the main assembly, disabled; where the disabled functional block does not take part in the generation of the output signals of the auxiliary assembly compared, or intended to be compared, with signals from the main assembly.

According to an embodiment, the auxiliary assembly comprises no functional block c in the generation of the output signals of the auxiliary assembly intended to be compared with signals from the main assembly.

According to an embodiment, each assembly of circuits is a central processing unit sub-system.

According to an embodiment, each sub-system comprises a circuit forming a central processing unit, at least one volatile memory circuit, at least one non-volatile memory circuit, a memory management unit, or at least one bus coupling the different circuits and a bus decoding circuit.

According to an embodiment, each circuit in the main assembly comprises at least two functional blocks.

According to an embodiment, at least one input of the auxiliary assembly, which does not take part in the generation of the output signals of the auxiliary assembly intended to be compared with signals from the main assembly, is maintained at a constant value.

According to an embodiment, all the inputs of the auxiliary assembly which do not take part in the generation of the output signals of the auxiliary assembly intended to be compared with signals from the main assembly are maintained at a constant value.

According to an embodiment, the circuits of the main assembly are located one next to the other on an integrated circuit, and the circuits of the auxiliary assembly are located one next to the other on the integrated circuit.

According to an embodiment, the minimum distance between a circuit of the main assembly and the equivalent circuit of the auxiliary assembly is 50 µm.

According to an embodiment, the minimum distance between the circuits of the main assembly and the circuits of the auxiliary assembly is 50 µm.

According to an embodiment, the main assembly comprises a first and a second multiplexers, and the auxiliary assembly comprises a third and a fourth multiplexer; an output of the first multiplexer being coupled to a first input of the second multiplexer and to a first input of the fourth multiplexer; an output of the second multiplexer being coupled to at least one circuit of the main assembly; an output of the fourth multiplexer being coupled to at least one circuit of the auxiliary assembly; a second input of the fourth multiplexer being coupled to an output of the third multiplexer; the second multiplexer being controlled by a first signal, and the fourth multiplexer being controlled by a second signal, the first and second signals being configured to have complementary states; the first input of the second multiplexer being selected when the first signal is in a first state; the first input of the fourth multiplexer being selected when the second signal is in a second state complementary to the first state.

According to an embodiment, inputs of the third multiplexer are configured to receive a constant value.

According to an embodiment, inputs of the first multiplexer are coupled to peripherals of the system coupled to at least one of the circuits of the main assembly.

According to an embodiment, the circuits of the main assembly comprise functional blocks, and the circuits of the auxiliary assembly comprise functional blocks equivalent to those of the main assembly; at least a first functional block of one of the circuits of the main assembly having an output coupled to a first input of a fifth multiplexer of the main assembly and to a first input of a sixth multiplexer of the auxiliary assembly; the first input of the fifth multiplexer being selected when a third signal is in a first state; the first input of the sixth multiplexer being selected when a fourth signal is in a second state, complementary to the first state.

According to an embodiment, a second input of the sixth multiplexer is selected when the fourth signal is in the first state; a second functional block of the auxiliary assembly, equivalent to the first functional block, being disabled.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an example of a "LOCKSTEP"-type system;

FIG. 2 illustrates an embodiment of "LOCKSTEP"-type system;

FIG. 3 illustrates another embodiment of a "LOCKSTEP"-type system; and

FIG. 4 illustrates an embodiment of a "LOCKSTEP"-type system.

### DETAILED DESCRIPTION OF ILLUSTRATIVE EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

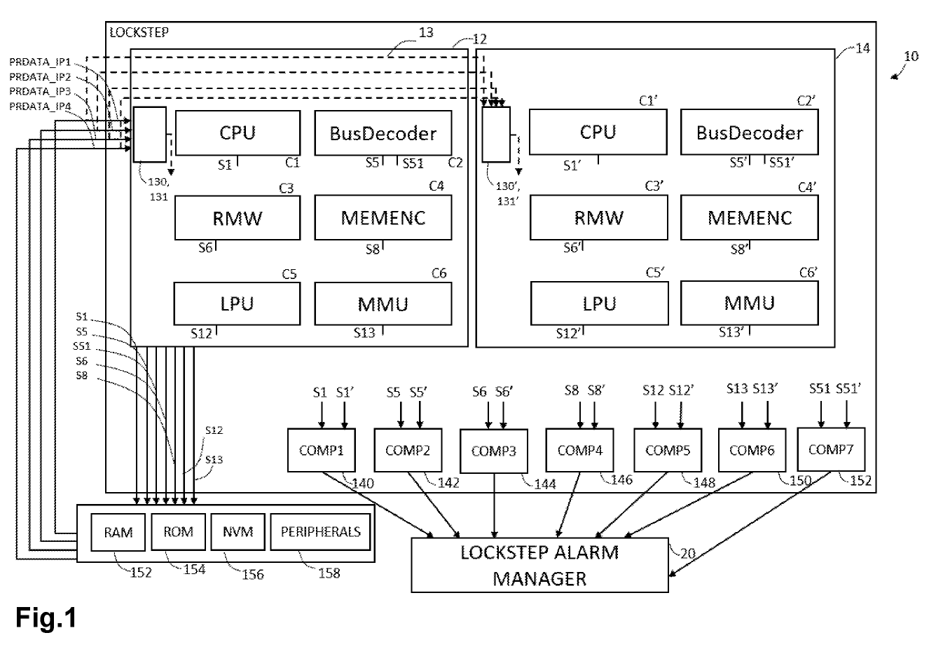

FIG. 1 shows an example of a "LOCKSTEP"-type system 10.

System 10 is for example incorporated in a microcontroller or a system-on-a-chip. System 10 for example comprises a wireless communication module, not shown.

System 10 comprises two assemblies of circuits 12 and 14. The two assemblies 12 and 14 form, for example, similar cores of system 10, working in parallel on the same operations to verify its correct operation.

Assemblies 12 and 14, for example, receive the same external conditions, such as the operating frequency, the same clock or transaction signals, or also the same interrupt signals.

Assembly 12 corresponds, for example, to a main assembly of circuits C1 (CPU), C2 (BusDecoder), C3 (RMW), C4 (MEMENC), C5 (LPU), C6 (MMU), 130, 131 shown in the form of functional blocks. Assembly 12 corresponds to the circuits having their operations involved in the operation of system 10. Thus, assembly 12 receives inputs, not shown, and delivers outputs. In the example of FIG. 1, assembly 12 delivers, for example, outputs S1, S5, S51, S6, S8, S12, S13, having their state compared with the corresponding, or equivalent, outputs of assembly 14. The outputs of assembly 12 are intended to be used by circuits 152 (RAM), 154 (ROM), 156 (NVM), 158 (PERIPHERALS) of system 10. Circuits 152 (RAM), 154 (ROM), 156 (NVM), 158 (PERIPHERALS) respectively correspond to circuits associated with one or more volatile memories, for example of RAM type, to circuits associated with one or more static or read-only memories, for example of ROM type, to circuits associated with one or more non-volatile memories (NVMs), for example of phase-change type, and to peripheral circuits, such as for example circuits linked to bus protocols such as the AHB, APB, or AXI protocols.

Assembly 14 corresponds to an auxiliary, or redundant, assembly of circuits, otherwise known as replica. Assembly 14 comprises, for example, the same circuits as assembly 12. In other words, assembly 14 has a design or an architecture, in the sense of the RTL (register level transfer) design protocol, which is the same as that of assembly 12. In an example, the operations performed by assembly 14 form a replica of the operations performed in assembly 12, but they do not take part in the actual operation of system 10, other than to verify, by comparison, the operation of assembly 12. Thus, assembly 14 receives the same commands, not shown, as assembly 12 and delivers outputs S1', S5', S51', S6', S8', S12', S13' configured to be compared with the outputs S1, S5, S51, S6, S8, S12, S13 of assembly 12.

In the example of FIG. 1, assembly 14 comprises circuits C1', C2', C3', C4', C5', C6' which are the equivalent circuits or replicas of the circuits C1, C2, C3, C4, C5, C6 of assembly 12. Circuits C1 to C6, and C1' to C6' respectively correspond, for example, to: a computing unit or processor (CPU), a bus protocol (BusDecoder), for example a bus matrix dedicated to the operation of AHB, APB, or AXI bus protocols; a byte translation unit (Read Modify Write, RWM) which translates write access bytes or half-words into 32-bit access words for code error detection; an encryption and scrambling circuit (MEMENC); a library protection unit (LPU) configured to protect an access to the code or to volatile or non-volatile data from the rest of system 10, and a memory management unit (MMU). Assembly 14 comprises circuits C1' to C6', respectively corresponding to the circuits C1 to C6 of assembly 12.

In an example, not shown, the type or the functions of the circuits of assemblies 12 and 14 is different from those shown as an example. Their number may also be different from that shown.

The circuits 130, 131 of assembly 12 and 130', 131' of assembly 14 are, for example, circuits of selection from among signals PRDATA_IP1, PRDATA_IP2, PRDATA_IP3, PRDATA_IP4, for example issued by circuits 152, 154, 156, 158. Signals PRDATA_IP1, PRDATA_IP2, PRDATA_IP3, PRDATA_IP4 are, for example, responses to transactions sent by assembly 12. In an example, signals PRDATA_IP1, PRDATA_IP2, PRDATA_IP3, PRDATA_IP4, form inputs of assemblies 12 and 14.

In an example, signals PRDATA_IP1, PRDATA_IP2, PRDATA_IP3, PRDATA_IP4 are also accompanied or replaced by handshake protocol signals, for example, signals of READY/VALID type.

In a non-illustrated example, the number of input signals of selection circuits 130, 131, 130', 131' is between 1 and 4 or greater than four.

In the shown example, signals PRDATA_IP1, PRDATA_IP2, PRDATA_IP3, PRDATA_IP4, are also directed, via conductive lines 13, to circuits 130' or 131' of assembly 14 in order to be selected.

Selection circuits 130, 131, 130', 131' are, for example, multiplexers. Their function is, for example, to select, depending on the state of a selection signal, one of a plurality of input signals (for example, PRDATA_IP1, PRDATA_IP2, PRDATA_IP3, PRDATA_IP4).

The selected signal is for example used by one or a plurality of circuits C1 to C6, and C1' to C6'.

In an example, assemblies 12 and 14 receive input signals, not shown, which are, for example, selected by selection circuits of assemblies 12 and 14.

The outputs S1, S5, S51, S6, S8, S12, S13 of the circuits C1 to C6 of assembly 12, for example, deliver at least one output configured to be compared with an equivalent output of assembly 14. In the example of FIG. 1, circuit C1 generates output S1, circuit C2 generates outputs S5, S51, circuit C3 generates output S6, circuit C4 generates output S8, circuit C5 generates output S12, and circuit C6 generates output S13. Outputs S1, S5, S51, S6, S8, S12, and S13 are thus configured to be compared with outputs of assembly 14. Other outputs, not shown, of assembly 12 are for example not intended to be compared with outputs of assembly 14.

The circuits C1' to C6' of assembly 14 deliver at least the outputs corresponding to the outputs of assembly 12 configured to be compared with outputs of assembly 14. Thus, in the example of FIG. 1, circuit C1' generates output S1' intended to be compared with output S1, circuit C2' generates outputs S5' and S51' intended to be compared with outputs S5 and S51, circuit C3' generates an output S6' intended to be compared with output S6, circuit C4' generates an output S8' intended to be compared with output S8, circuit C5' generates an output S12' intended to be compared with output S12, and circuit C6' generates an output S13' intended to be compared with output S13.

In an example, some or all of the signals present on outputs S1, S5, S51, S6, S8, S12, S13, S1', S5', S51', S6', S8', S12', S13', are, for example, signals of memory access, for example to memories 152, 154 or 156. In an example, signals used in the ARM® architecture: HADDR, HTRANS, HPROT, HSIZE, HWRITE, HWDATA are present on outputs S1, S5, S51, S6, S8, S12, S13, S1', S5', S51', S6', S8', S12', S13'. The number of outputs will be adapted by those skilled in the art with the number of different types of signal to be compared within the framework of the "LOCKSTEP" architecture.

In an example, some or all of the signals present on outputs S1, S5, S51, S6, S8, S12, S13, S1', S5', S51', S6', S8', S12', S13', are, for example, signals related to security or cryptography, or memory location selection signals. In an example, signals used in the ARM® architecture: HSEL, HSEL_NVM, HSEL_RAM, HSEL_NESRAM, HSEL_ROM, HADDR_ENCR, HADDR_SCR_DATA, HADDR_SCR_CODE, HADDR_EDC_32, HADDR_EDC_64 are present on outputs S1, S5, S51, S6, S8, S12, S13, S1', S5', S51', S6', S8', S12', S13'.

System 10 further comprises one or more comparison circuits 140 (COMP1), 142 (COMP2), 144 (COMP3), 146 (COMP4), 148 (COMP5), 150 (COMP6), 152 (COMP7), which are, for example, comparator circuits, each configured to respectively compare the state of one of the outputs S1, S5, S51 S6, S8, S12, and S13 of assembly 12 with the state of the equivalent output of assembly 14. In the example of FIG. 1, system 10 comprises as many comparison circuits as there are outputs of assembly 12 intended to be compared with outputs of assembly 14. Thus, in the example of FIG. 1, system 10 comprises a circuit 140 (COMP1) configured to compare outputs S1 and S1', a circuit 142 (COMP2) configured to compare outputs S5 and S5', a circuit 144 (COMP3) configured to compare outputs S6 and S6', a circuit 146 (COMP4) configured to compare outputs S8 and S8', a circuit 148 (COMP4) configured to compare outputs S12 and S12' (COMP5), a circuit 150 (COMP6) configured to compare outputs S13 and S13', and a circuit 152 (COMP7) configured to compare outputs S51 and S51'.

Circuits 140, 142, 144, 146, 148, 150, 152 generate a respective alarm signal when one of the outputs (or the output state) S1, S5, S51, S6, S8, S12, S13, of assembly 12 is different from the corresponding output S1', S5', S51', S6', S8', S12', S13' of assembly 14. The alarm signals are, for example, supplied to a circuit 20 (LOCKSTEP ALARM MANAGER) configured to determine the response of system 10 to be made in case of a reception of an alarm signal resulting from the detection of a difference between the output signals of assembly 12 and of assembly 14. In an example, circuit 20 is configured, for example, to block the memory accesses, or generate a system alarm, switch off system 10, or reboot system 10, in case of differences between at least one of the outputs of assembly 12 and the corresponding outputs of assembly 14.

In an example, not shown, comparison circuits 140, 142, 144, 146, 148, 150, 152 are duplicated or even triplicated so as to create redundancy and ascertain that the alarm signals are not deliberately set to zero to mask alerts in the case of attacks.

Assemblies 12, 14 and comparison circuits 140 to 152 form a "LOCKSTEP"-type architecture. This system is used, for example, in banking, authentication, or security applications.

The "LOCKSTEP"-type architecture shown in FIG. 1 is a source of significant power consumption in system 10, which may account, for example, for one third of the general power consumption.

Selection circuits 130, 131, 130, 131 account for a non-negligible proportion of this power consumption.

The "LOCKSTEP"-type architecture shown in FIG. 1 also takes up significant space on the substrate in which it is manufactured.

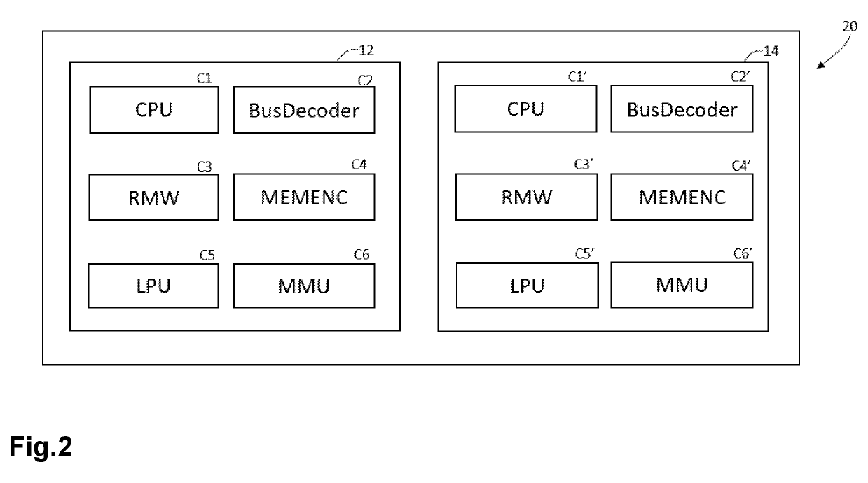

The embodiments illustrated in FIGS. 2 to 4 provide overcoming all or part of the issues raised by the system illustrated in FIG. 1.

FIG. 2 shows an embodiment of a "LOCKSTEP"-type system 20. More specifically, FIG. 2 schematically illustrates the layout of system 20.

System 20 comprises, for example, the elements of the LOCKSTEP-type system of FIG. 1. Thus, system 20 comprises the assemblies 12 and 14 and the circuits C1 to C6 and C1' to C6' of FIG. 1. System 20 further comprises, for example, circuits 140, 142, 144, 146, 148, 150, 152, not shown in FIG. 2.

The circuits C1 to C6 of assembly 12 are for example located on a same substrate, for example, a same integrated circuit. Similarly, circuits C1' to C6' are located on the same integrated circuit, for example, the same integrated circuit as that of assembly 12. Preferably, the circuits of assemblies 12 and 14 are located on a same integrated circuit.

The circuits C1 to C6 and C1' to C6' of FIG. 2 are represented by blocks. The placing of the blocks representing circuits C1 to C6 and C1' to C6' indicates their positioning on an integrated circuit. Thus, circuits C1 to C6 are, in the embodiment shown in FIG. 2, placed side by side. Preferably, only the circuits forming part of assembly 12 are arranged in the physical space represented by circuits C1 to C6. Preferably, only the circuits forming part of assembly 14 are arranged in the physical space represented by circuits C'1 to C'6. In particular, none of circuits C1' to C6' is located in the physical space taken up by circuits C1 to C6, and conversely.

Preferably, the minimum distance between two equivalent circuits, C1 and C1' or C2 and C2' etc., of assemblies 12 and 14, is 50 µm. More generally, the minimum distance between a circuit of assembly 12 and a circuit of assembly 14 is preferably 50 µm.

The circuits of assembly 12 may be separated from the circuits of assembly 14 by other circuits or components, for example by other circuits of system 20. For example, comparison circuits 140, 142, 144, 146, 148, 150, 152 are for example located between the circuits of assembly 12 and the circuits of assembly 14.

The arrangement of the circuits of assembly 12 may be different from the arrangement of the circuits of assembly 14. Thus, the circuits of assembly 14 may be separated from one another by distances different from the distances separating the circuits of assembly 12.

An advantage of the embodiment of FIG. 2 is that the connections, for example wired, between the various circuits of a same assembly are shorter and are not disturbed by the connections of the other assembly. Such shorter links ensure a lower power consumption of the system.

Another advantage of the embodiment of FIG. 2 is that the separation of the circuits of the two assemblies ensures that an attack on one of the assemblies does not cause modification to the other assembly, and thus ensures that the attack can be identified by its impact on one of the circuits.

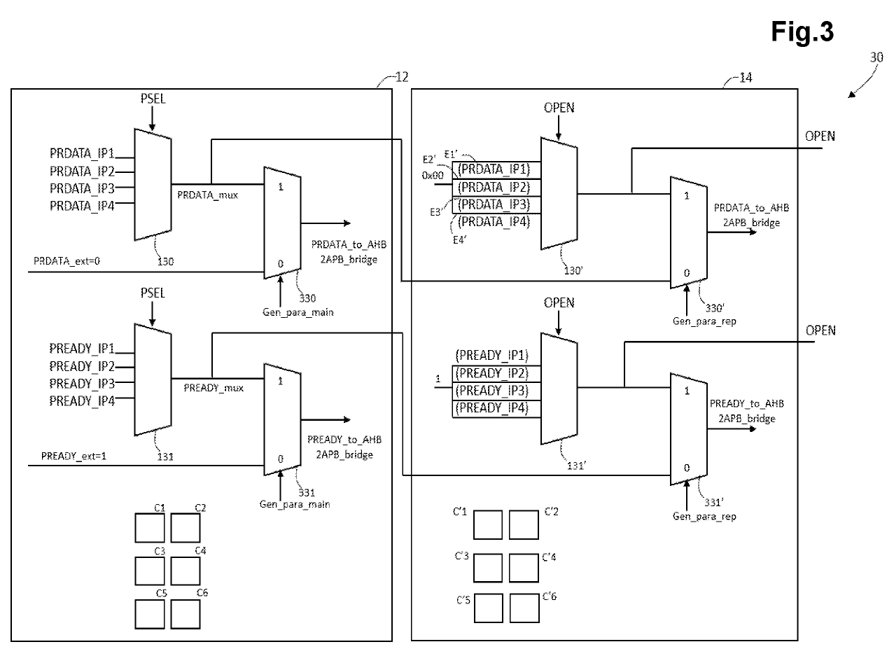

FIG. 3 shows another example of a "LOCKSTEP"-type system 30.

System 30 comprises the elements of the system 10 of FIG. 1, except for conductive lines 13, which are absent in this example. Thus, system 30 comprises assemblies 12 and 14 with circuits C1 to C6 and C1' to C6'. System 30 further comprises circuits 140, 142, 144, 146, 148, 150, 152 as well as peripherals 152, 154, 156, 158, which are not shown herein.

FIG. 3 further shows selection circuits 130, 131, 130', and 131'.

Circuits 130, 131, 130', and 131' are, in the shown example, multiplexers.

Multiplexer 130 receives as inputs signals PRDATA_IP1, PRDATA_IP2, PRDATA_IP3, and PRDATA_IP4 from peripherals 152, 154, 156, 158, for example, as a result of one or more transactions implemented by one or more of circuits C1, C2, C3, C4, C5, or C6. Multiplexer 130 is controlled by a signal PSEL, for example originating from circuit C1. The output of multiplexer 130 (signal PRDATA_mux) is coupled, preferably connected, to an input designated as "1" of a multiplexer 330 of assembly 12 and to an input designated as "0" of a multiplexer 330' of assembly 14, which is a circuit equivalent to multiplexer 330.

In the shown example, multiplexer 330 is controlled by the state of a signal Gen_para_main and multiplexer 330' is controlled by the state of a signal Gen_para_rep. The state of signal Gen_para_main is given by a parameter, for example programmed, of assembly 12, which is 1 for example. The state of signal Gen_para_rep is given by a parameter, for example programmed, of assembly 14 and which is different from Gen_para_main, that is, here Gen_para_rep = 0. In an example, the states of signals Gen_para_rep and Gen_para_main are complementary, when Gen_para_rep is 0, Gen_para_main is 1.

Multiplexer 330 has a second input designated as "0" which receives a signal called PRDATA_ext = 0 which is set to zero. Thus, when signal Gen_para_main is 1, the "1" input of multiplexer 330 is selected, and when Gen_para_main is 0, the "0" input of multiplexer 330 is selected.

The signal selected at the output of multiplexer 330 is designated as PRDATA_to_AHB2APB_bridge and is used, for example, by one or more of circuits C1' to C6'.

Multiplexer 330' has an input designated as "1" which is coupled to an output of multiplexer 130'. Thus, when signal Gen_para_rep is 0, the "0" input of multiplexer 330' is selected, and when Gen_para_rep is 1, the "1" input of multiplexer 330' is selected.

The output of multiplexer 130 being coupled to the "0" input of multiplexer 330', the output of multiplexer 330' PRDATA_to_AHB2APB_bridge is, in normal operation, the same as the output of multiplexer 130 and is coupled, for example, to one or more of circuits C1' to C6'.

In the shown example, the output of multiplexer 130 having already been selected in assembly 12 and coupled to the 0 input of multiplexer 330', there is no need to operate multiplexer 130'. Thus, unlike the example of FIG. 1, the inputs of multiplexer 130' are not coupled to the inputs of multiplexer 130. The lines conveying signals PRDATA_IP1, PRDATA_IP2, PRDATA_IP3, and PRDATA_IP4 to multiplexer 130' in FIG. 1 are, this time, absent from FIG. 3. In FIG. 3, the inputs of multiplexer 130' are noted in brackets (PRDATA_IP1), (PRDATA_IP2), (PRDATA_IP3), (PRDATA_IP4) to signify the absence of lines conveying signals PRDATA_IP1, PRDATA_IP2, PRDATA_IP3, and PRDATA_IP4 to multiplexer 130'.

In other words, in FIG. 3, the inputs of multiplexer 130' are not used for the operation of one of circuits C1' to C6' and are thus not used in fine for the comparison of operation between assemblies 12 and 14 with one of circuits 140, 142, 144, 146, 148, 150, 152.

The fact of introducing, with respect to the example of FIG. 1, multiplexers 330 and 330', which are controlled in opposite fashion (Gen_para_rep = 0 when Gen_para_main = 1), and of coupling the output of multiplexer 130 to an input of multiplexer 330' corresponding to the value of parameter Gen_para_rep = 0, enables to do without an active operation of multiplexer 130'. Multiplexer 130' thus becomes transparent with respect to circuits 140, 142, 144, 146, 148, 150, 152. Instead of signals PRDATA_IP1, PRDATA_IP2, PRDATA_IP3, and PRDATA_IP4, the inputs of multiplexer 130' are all set to a fixed value which is, for example, as in FIG. 3, a zero value or 0x00.

In other words, at least one input of assembly 14 not involved in the generation of the output signals of assembly 14 intended to be compared with signals from assembly 12 is kept at a constant value (here 0x00 or 0 or 1).

Since multiplexer 130' does not need to be controlled since its inputs are identical and the selection has already been performed in multiplexer 130, its control terminal is left floating (OPEN) or fixed.

The fact of not having to couple the inputs of multiplexer 130' to the inputs of multiplexer 130 and of applying a fixed value (here 0x00) to all the inputs of multiplexer 130' enables to save space on the substrate by removing the lines coupling the inputs of multiplexers 130 and 130'. Indeed, these lines are configured for 32-bit signals, for example, which takes up non-negligible space on the substrate. This also enables to decrease the power consumption, since there is no further need to actuate multiplexer 130'.

Multiplexer 131 receives as inputs signals PREADY_IP1, PREADY_IP2, PREADY_IP3, and PREADY_IP4 for example issued by peripherals 152, 154, 156, 158, for example, as a result of one or more transactions implemented by one or a plurality of circuits C1, C2, C3, C4, C5, or C6. Multiplexer 131 is controlled by a signal PSEL, for example issued by circuit C1. The output of multiplexer 131 (signal PREADY_mux) is coupled, preferably connected, to an input designated as "1" of a multiplexer 331 of assembly 12 and to an input designated as "0" of a multiplexer 331' of assembly 14, which is a circuit equivalent to multiplexer 331.

In the shown example, multiplexer 331 is controlled by the state of signal Gen_para_main and multiplexer 331' is controlled by the state of signal Gen_para_rep.

Multiplexer 331 has a second input designated as "0" which receives a signal called PREADY_ext = 1, which is set to the high state or 1. Thus, when signal Gen_para_main is 1, the "1" input of multiplexer 331 is selected, and when Gen_para_main is 0, the "0" input of multiplexer 331 is selected.

The signal selected at the output of multiplexer 331 is designated as PREADY_to_AHB2APB_bridge and is used, for example, by one or more of circuits C1' to C6'.

Multiplexer 331' has an input designated as "1" which is coupled to an output of multiplexer 131'. Thus, when signal Gen_para_rep is 0, the "0" input of multiplexer 331' is selected, and when Gen_para_rep is 1, the "1" input of multiplexer 331' is selected.

The output of multiplexer 131 being coupled to the "0" input of multiplexer 331', the output of multiplexer 331' PREADY_to_AHB2APB_bridge is, in normal operation, the same as the output of multiplexer 131 and is coupled, for example, to one or more of circuits C1' to C6'.

In the shown example, the output of multiplexer 131 already having been selected in assembly 12 and coupled to the 0 input of multiplexer 331', there is no further need to operate multiplexer 131'. Thus, the inputs of multiplexer 131' are not coupled to the inputs of multiplexer 131. The lines conveying signals PREADY_IP1, PREADY_IP2, PREADY_IP3, and PREADY_IP4 to the multiplexer 131' of FIG. 1 are this time absent from FIG. 3. In FIG. 3, the inputs of multiplexer 131' are noted in brackets (PREADY_IP1), (PREADY_IP2), (PREADY_IP3), (PREADY_IP4) to signify the absence of lines conveying signals PREADY_IP1, PREADY_IP2, PREADY_IP3, and PREADY_IP4 to multiplexer 131'.

In other words, in FIG. 3, the inputs of multiplexer 131' are not used for the operation of one of circuits C1' to C6' and thus are not used in fine for the comparison of operation between assemblies 12 and 14 with one of circuits 140, 142, 144, 146, 148, 150, 152.

The fact of introducing multiplexers 331 and 331', which are controlled in opposite fashion (Gen_para_rep = 0 when Gen_para_main = 1), and of coupling the output of multiplexer 131 to an input of multiplexer 331' which corresponds to the value of parameter Gen_para_rep = 0, enables to do without an active operation of multiplexer 131'. Multiplexer 131' thus becomes transparent with respect to circuits 140, 142, 144, 146, 148, 150, and 152. Instead of signals PREADY_IP1, PREADY_IP2, PREADY_IP3, and PREADY_IP4, the inputs of multiplexer 131' are all set to a fixed value which is, for example, as in FIG. 3, a zero value or 0x00. Since multiplexer 131' does not need to be controlled since its inputs are identical and the selection has already been performed at the level of multiplexer 131, its control terminal is left floating (OPEN) or fixed.

The fact of not having to couple the inputs of multiplexer 131' to the inputs of multiplexer 131, and of applying a fixed value (here high state or 1) to all the inputs of multiplexer 131', enables to save space on the substrate by removing the lines coupling the inputs of multiplexers 131 and 131'. Indeed these lines are configured for 32-bit signals, for example, which takes up non-negligible space on the substrate. This also enables to limit the power consumption, since it is no longer needed to actuate multiplexer 131'.

In the shown example, the outputs of multiplexers 130' and 131' having no influence on the operation of circuits C1' to C6', they are noted "OPEN".

In more general and non-illustrated fashion, assembly 12 receives inputs, where the number of inputs may, in practice, be any number. These inputs are supplied to circuits C1 to C6 so as to generate outputs S1, S5, S51, S6, S8, S12, and S13.

As described with the inputs of multiplexers 130' and 131', not all the inputs which correspond to the inputs of assembly 12 are coupled to assembly 14. By introducing two-input multiplexers in each assembly, such as for example multiplexers 330 and 331, or multiplexers 330' and 331', which are each controlled according to parameters of different value (0 and 1), and by coupling them as described in the above examples, it is possible to obtain inputs of assembly 14 which are not used to generate the outputs intended to be compared with outputs of assembly 12. These inputs of assembly 14 are thus set to constant values (for example, 0 (0x00) or ground or a high state or 1) without for this to affect the result of the comparisons of circuits 140, 142, 144, 146, 148, 150, 152.

This enables to save space on the substrate by removing conductive lines. This also enables to limit the power consumption, since there is no further need to actuate certain "large" multiplexers of assembly 14.

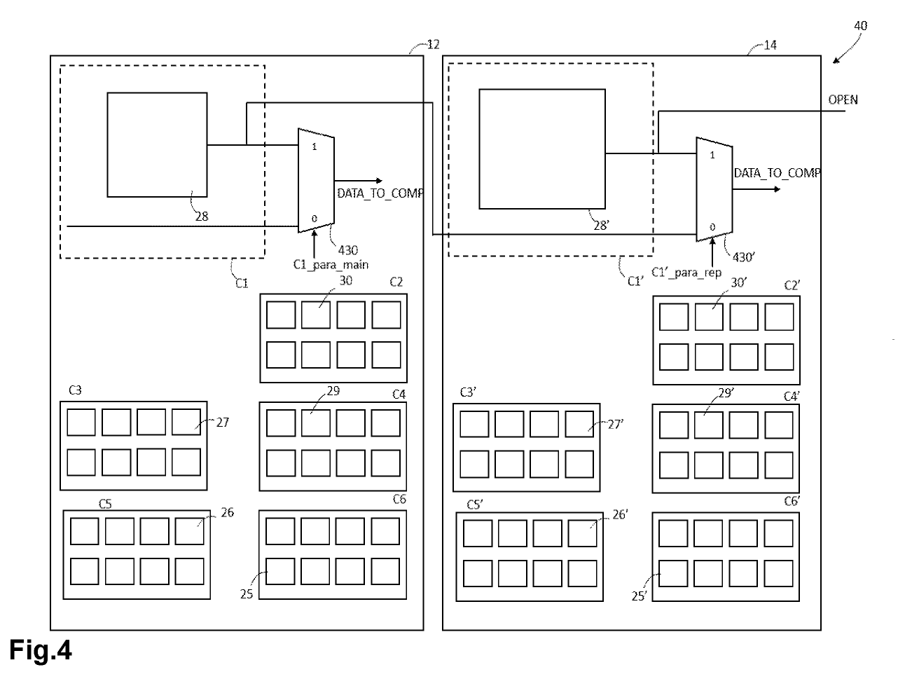

FIG. 4 illustrates an embodiment of a "LOCKSTEP"-type system 40. More specifically, FIG. 4 schematically illustrates a composition of the circuit of assemblies 12 and 14.

System 40 is, for example, similar to the system 10 of FIG. 1 or to the system 30 of FIG. 3. Thus, system 40 comprises assemblies 12 and 14 and circuits C1 to C6 and C1' to C6'. System 40 further comprises, for example, circuits 130, 131, 130', 131', 140, 142, 144, 146, 148, 150, 152, or 330, 331, 330', 331', but which are not shown in FIG. 4.

In the shown example, circuit C1 comprises, for example, sub-circuits, or functional blocks, 28, circuit C2 comprises, for example, sub-circuits 30, circuit C3 comprises, for example, sub-circuits 27, circuit C4 comprises, for example, sub-circuits 29, circuit C5 comprises, for example, sub-circuits 26, and circuit C6 comprises, for example, sub-circuits 25.

In the shown example, circuit C'1 comprises, for example, sub-circuits, or functional blocks, 28', circuit C2' comprises, for example, sub-circuits 30', circuit C3' comprises, for example, sub-circuits 27', circuit C4' comprises, for example, sub-circuits 29', circuit C5' comprises, for example, sub-circuits 26', and circuit C6' comprises, for example, sub-circuits 25'.

In the example of FIG. 4, each of circuits C1 to C6 or C1' to C6' comprises eight sub-circuits. In practice, the circuits of assemblies 12 and 14 may each have any number of sub-circuits, preferably at least two sub-circuits. The sub-circuits of a same circuit are, for example, capable of operating independently of one another. For reasons of clarity, in FIG. 4, a single sub-circuit 28 of circuit C1 is shown, as well as a single sub-circuit 28' of circuit C1'.

The functions of the sub-circuits are, for example, read and/or write access control and/or access recovery. Other functions implement bridges of APHB-to-APB type, for the translation of the AHB-type protocol into an APB-type protocol. APB decoders are for example also implemented to generate signals of selection of the APB-type peripherals. These functions are implemented, for example, by the sub-circuits of circuit C2.

Each sub-circuit is, for example, configured to receive at least one input, not shown. Each sub-circuit is, for example, configured to deliver at least one output. The outputs of each circuit C1 to C6, or C'1 to C6', for example, are generated by part of the sub-circuits of the circuit.

In certain cases, some of the sub-circuits of assembly 12 are not involved in the generation of the signals used by circuits 140, 142, 144, 146, 148, 150, 152. It then becomes possible to save energy by disabling the corresponding sub-circuits of the concerned assembly 14.

In the example of FIG. 4, at least one parameter is assigned to each sub-circuit. For circuit C1, the parameter is designated as C1_para_main, and for circuit C1', the parameter is designated as C1'_para_rep. Further, at least one additional multiplexer is added for each sub-circuit in assembly 12 and assembly 14.

In the shown example, an output of sub-circuit 28 is coupled to an input called "1" of a multiplexer 430 which is, for example, similar to multiplexer 330. An input called "0" of multiplexer 430 is for example set to zero or to ground or to the low state. The output of the sub-circuit is also coupled to an input called "0" of a multiplexer 430', for example similar to the multiplexer 330' of assembly 14. Multiplexer 430 is controlled by the state or the value of parameter C1_para_main. When parameter C1_para_main = 1, then the "1" input of multiplexer 430 is selected. When parameter C1_para_main = 0, then the "0" input of multiplexer 430 is selected. The output of multiplexer 430 (signal DATA_TO_COMP) is sent to one of circuits 140, 142, 144, 146, 148, 150, 152.

In the shown example, an output of sub-circuit 28' is coupled to an input designated as "1" of multiplexer 430'. Multiplexer 430' is controlled by the state or the value of parameter C1'_para_rep. When parameter C1'_para_rep = 1, then the "1" input of multiplexer 430' is selected. When parameter C1_para_rep = 0, then the "0" input of multiplexer 430 is selected. The output of multiplexer 430' (signal DATA_TO_COMP) is, for example, sent to one of comparators 140, 142, 144, 146, 148, 150, 152.

When C1_para_main = 1 and C1'_para_rep = 0, that is, when C1_para_main and C1_para_rep are in different states, this results in sub-circuit 28' being capable of being disabled, since the output of sub-circuit 28 (DATA_TO_COMP) is at the output of multiplexer 430, and also at the output of multiplexer 430'. Sub-circuit 28' thus becomes transparent to comparators 140, 142, 144, 146, 148, 150, 152, and can thus be disabled. By disabled, there is meant that sub-circuit 28' is not powered, for example.

An advantage of the embodiment of FIG. 4 is that the disabling of the sub-circuits which do not take part in the generation of the compared outputs decreases the power consumption.

Various embodiments and variants have been described. Those skilled in the art will understand that certain features of these various embodiments and variants may be combined, and other variants will occur to those skilled in the art. In particular, the embodiments of FIGS. 3 and 4 may be combined to both disable multiplexers 330, 331' and disable certain sub-circuits of assembly 14.

Finally, the practical implementation of the described embodiments and variants is within the abilities of those skilled in the art based on the functional indications given hereabove. In particular, multiplexers similar to multiplexers 430 and 430' may be added for each sub-circuit of each of the circuits C1 to C6 and C1' to C'6. In an example, multiplexers 130, 131, 130', 130', 330, 330', 331, 331' may be integrated into one or more of the circuits or sub-circuits.

What is claimed is:

1. A system comprising:
a main assembly of circuits; and
an auxiliary assembly of circuits, the main and auxiliary assemblies comprising equivalent circuits;
wherein each circuit of the main assembly is configured to deliver at least one output signal intended to be compared with a corresponding output signal generated by a respective circuit of the auxiliary assembly;
wherein at least one circuit of the auxiliary assembly comprises an auxiliary functional block, equivalent to a main functional block of the main assembly, that is configured to be disabled; and
wherein the auxiliary functional block, when disabled, does not take part in a generation of the output signals of the auxiliary assembly intended to be compared with the output signals of the main assembly.

2. System according to claim 1, wherein the auxiliary functional block, when not disabled, takes part in the generation of the output signals of the auxiliary assembly intended to be compared with the output signals from the main assembly.

3. The system according to claim 1, wherein each assembly of circuits is a sub-system with a central processing unit.

4. The system according to claim 3, wherein each sub-system comprises a first circuit including the central processing unit, at least one volatile memory circuit, at least one non-volatile memory circuit, a memory management unit, at least one bus coupling the circuits of the respective sub-system, and a bus decoding circuit.

5. The system according to claim 1, wherein each circuit of the main assembly comprises at least two main functional blocks.

6. The system according to claim 1, wherein at least one input of the auxiliary assembly, which does not take part in the generation of the output signals of the auxiliary assembly intended to be compared with the output signals of the main assembly, is maintained at a constant value.

7. The system according to claim 1, wherein all inputs of the auxiliary assembly, which do not take part in the generation of the output signals of the auxiliary assembly intended to be compared with the output signals of the main assembly, are maintained at respective constant values.

8. The system according to claim 1, wherein the circuits of the main assembly are located one next to another on an integrated circuit, and the circuits of the auxiliary assembly are located one next to another on the integrated circuit.

9. The system according to claim 1, wherein a minimum distance between a circuit of the main assembly and the equivalent circuit of the auxiliary assembly is about 50 µm.

10. The system according to claim 1, wherein a minimum distance between the circuits of the main assembly and the circuits of the auxiliary assembly is about 50 µm.

11. The system according to claim 1, wherein:
the main assembly comprises first and second multiplexers;
the auxiliary assembly comprises third and fourth multiplexers;
an output of the first multiplexer is coupled to a first input of the second multiplexer and to a first input of the fourth multiplexer;
an output of the second multiplexer is coupled to one or more circuits of the main assembly;
an output of the fourth multiplexer is coupled to one or more circuits of the auxiliary assembly;
a second input of the fourth multiplexer is coupled to an output of the third multiplexer;
the second multiplexer is controlled by a first signal, and the fourth multiplexer is controlled by a second signal, the first and second signals having complementary states;
the first input of the second multiplexer is configured to be selected in response to the first signal being in a first state; and
the first input of the fourth multiplexer is configured to be selected in response to the second signal being in a second state complementary to the first state.

12. The system according to claim 11, wherein inputs of the third multiplexer are configured to receive a constant value.

13. The system according to claim 11, wherein inputs of the first multiplexer are coupled to peripherals of the system coupled to at least one of the circuits of the main assembly.

14. The system according to claim 1, wherein:
the circuits of the main assembly comprise main functional blocks;
the circuits of the auxiliary assembly comprise auxiliary functional blocks equivalent to those of the main assembly;
at least one first functional block of one of the circuits of the main assembly has an output coupled to a first input of a fifth multiplexer of the main assembly and to a first input of a sixth multiplexer of the auxiliary assembly;
the first input of the fifth multiplexer is configured to be selected in response to a third signal being in a first state; and
the first input of the sixth multiplexer is configured to be selected in response to a fourth signal being in a second state that is complementary to the first state.

15. The system according to claim 14, wherein:
a second input of the sixth multiplexer is configured to be selected in response to the fourth signal being in the first state; and
a second functional block of the auxiliary assembly, equivalent to the first functional block, is disabled.

16. A system comprising:
a main assembly of circuits; and
an auxiliary assembly of circuits, the main and auxiliary assemblies comprising equivalent circuits, and each assembly of circuits being a sub-system with a central processing unit;
wherein each circuit of the main assembly is configured to deliver at least one output signal intended to be compared with a corresponding output signal generated by a respective circuit of the auxiliary assembly;
wherein at least one circuit of the auxiliary assembly comprises an auxiliary functional block, equivalent to a main functional block of the main assembly, that is configured to be disabled;
wherein the auxiliary functional block, when disabled, does not take part in a generation of the output signals of the auxiliary assembly intended to be compared with the output signals of the main assembly; and
wherein the auxiliary functional block, when not disabled, takes part in the generation of the output signals of the auxiliary assembly intended to be compared with the output signals from the main assembly.

17. The system according to claim 16, wherein each sub-system comprises a first circuit including the central processing unit, at least one volatile memory circuit, at least one non-volatile memory circuit, a memory management unit, at least one bus coupling the circuits of the respective sub-system, and a bus decoding circuit.

18. The system according to claim 16, wherein each circuit of the main assembly comprises at least two main functional blocks.

19. The system according to claim 16, wherein at least one input of the auxiliary assembly, which does not take part in the generation of the output signals of the auxiliary assembly intended to be compared with the output signals of the main assembly, is maintained at a constant value.

20. The system according to claim 16, wherein the circuits of the main assembly are located one next to another on an integrated circuit, and the circuits of the auxiliary assembly are located one next to another on the integrated circuit.
